(19) United States
(12) Patent Application Publication
(10) Pub. No.: US 2008/0292871 A1
(43) Pub. Date: Nov. 27, 2008

(54) Optical Film Device

(76) Inventors: Cheng-Hsin Yeh, Taoyuan Hsien (TW); Chin-Wan Jseng, Taoyuan Hsien (TW); Nai-Yun Liang, Taoyuan Hsien (TW); Chiao-Ning Huang, Taoyuan Hsien (TW); Yi-Jing Lin, Taoyuan Hsien (TW); Chin-Wei Lu, Taoyuan Hsien (TW)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 12/143,138

(22) Filed: Jun. 20, 2008

Related U.S. Application Data
(63) Continuation-in-part of application No. 11/751,705, filed on May 22, 2007.

(30) Foreign Application Priority Data
Nov. 26, 2007 (TW) 096219960

(51) Int. Cl. B32B 5/16

(52) U.S. Cl. 428/323

(57) ABSTRACT

An optical film device includes a laminate. The laminate includes a plurality of functional layers. The functional layers include a transparent anti-glare film which incorporates a plurality of water-soluble scattering particles distributed therein. The anti-glare film further includes a plurality of indentations distributed on a surface of the anti-glare film.

### CROSS-REFERENCE TO RELATED APPLICATIONS

This application is a continuation-in-part of co-pending U.S. patent application Ser. No. 11/751,705, filed on May 22, 2007. This application also claims priority of Taiwanese application No. 096219960, filed on Nov. 26, 2007.

### BACKGROUND OF THE INVENTION

1. Field of the Invention

The invention relates to an optical film device, more particularly to an optical film device comprising a plurality of functional layers including a transparent anti-glare film.

2. Description of the Related Art

An optical film device is used to cover a screen of a display device so as to protect the screen and to enhance viewing comfort. The optical film device comprises a laminate including a hard coat, an anti-static hard coat, an anti-glare film, an anti-reflection film, a low reflection film, etc.

Conventionally, the anti-glare film is made of a transparent resin incorporating a plurality of scattering particles distributed therein. The ambient light that reaches the anti-glare film is reflected, refracted and/or scattered by the particles so as to reduce the brightness of the light reflected from the film. The scattering particles are conventionally made of an inorganic material, such as silica, zirconia, titania, alumina, and stannic oxide, or an organic material, such as polystyrene, polymethylmethacrylate, and acrylate-styrene copolymer.

However, the light emitting from the display device is also refracted and/or scattered fay the particles, which in turn reduces the clarity of the images seen on the display device.

### SUMMARY OF THE INVENTION

Therefore, it is an object of the present invention to provide an optical film device which provides multiple functions including the anti-glaring effect while maintaining satisfactory clarity.

Accordingly, the optical film device of this invention comprises a laminate including a plurality of functional layers. The functional layers include a transparent anti-glare film incorporating a plurality of water-soluble scattering particles distributed therein.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a first, preferred embodiment of an optical film device according to this invention;

FIG. 2 is a schematic view of a second preferred embodiment of an optical film device according to this invention; and

FIG. 3 is a schematic view of a third preferred embodiment of an optical film device according to this invention.

### DETAILED DESCRIPTION OF THE PREFERRED EMBODIMENTS

Before the present invention is described in greater detail, it should be noted that like elements are denoted by the same reference numerals throughout the disclosure.

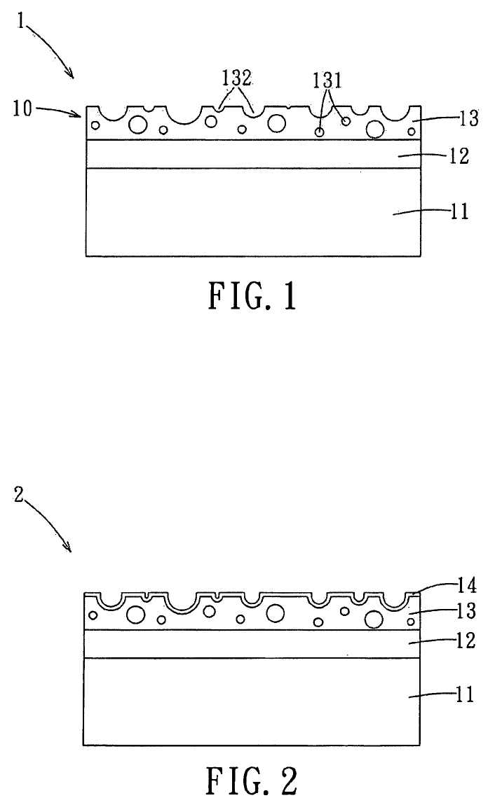

Referring to FIG. 1, there is shown an optical film device 1 according to the first preferred embodiment of this invention which includes a laminate 10 and a light-transmissive substrate 11 supporting the laminate 10. The laminate 10 includes a transparent anti-glare film 13 and a hard coat 12 disposed between the transparent anti-glare film 13 and the light-transmissive substrate 11.

Preferably, the light-transmissive substrate 11 is made of a flexible plastic material, such as triacetyl cellulose, polyethylene terephthalate, polycarbonate, or the like. In the preferred embodiment, the light-transmissive substrate 11 is made of triacetyl cellulose. The thickness of the light-transmissive substrate 11 is preferably about 80 μm.

The hard coat 12 provides scratch resistance to the optical film device 1. The hard coat 12 is made of any suitable hard coat material commonly used in the optical film. Examples of the suitable hard coat material are an acrylate resin, an acrylic resin, an acetal resin, an epoxy resin, polyurethane, or the like. The thickness of the hard coat 12 preferably ranges from 3 to 10 μm. In the preferred embodiment, the hard coat 12 is made of 5537C-50 (acrylate resin commercially available from Eternal Chemical Co. Ltd., Taiwan), and has a thickness of 6 μm. Alternatively, the hard coat 12 can be replaced with an anti-static hard coat so as to provide anti-static and scratch resistant properties to the optical film device 1. An example of the suitable material for the anti-static hard coat is C-4101, a coating material commercially available from Pelnox Ltd., Japan.

The transparent anti-glare film 13 incorporates a plurality of water-soluble scattering particles 131 distributed therein, and includes a plurality of indentations 132 distributed on a surface thereof.

The water-soluble scattering particles 131 are preferably colloidal particles made of gelatin, hydrogel, polyvinyl alcohol, or the like,

The transparent anti-glare film 13 is made of an ultraviolet curable resin, a thermoplastic resin, a thermosetting resin, or the like. An example of the ultraviolet curable resin is an acrylate resin. Examples of the thermoplastic resin include an acrylic resin, an acetal resin, or the like. Examples of the thermosetting resin include an epoxy resin, polyurethane, or the like. In the preferred embodiment, the transparent anti-glare film 13 is made of an acrylate resin.

Details of the transparent anti-glare film 13 and the method for making the same are disclosed in co-pending U.S. patent application Ser. No. 11/751,705, which is incorporated by reference herein in its entirety.

Referring to FIG. 2, there is shown an optical film device 2 according to the second preferred embodiment of this invention which is similar to the optical film device 1 of the first preferred embodiment except that the optical film device 2 further includes a low reflection film or an anti-reflection film 14 covered on the anti-glare film 13. An example for the low reflection film 14 is TU2164 (a low refraction index coating material commercially available from JSR Corporation). The thickness of the low reflection film 14 preferably ranges from 80 to 120 nm.

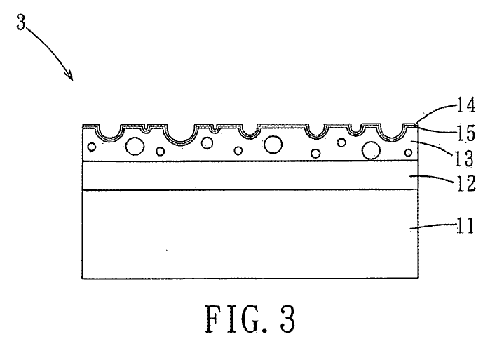

Referring to FIG. 3, there is shown an optical film device 3 according to the third preferred embodiment of this invention which is similar to the optical film device 1 of the first preferred embodiment except that the optical film device 3 further includes an anti-static hard coat 15 covered on the anti-glare film 13, and a low reflection film or an anti-reflection film 14 covered on the anti-static hard coat 15. The thickness of the anti-static hard coat 15 preferably ranges from 80 to 120 nm.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. An optical film device, comprising;
a laminate including a plurality of functional layers, said functional layers including a transparent anti-glare film incorporating a plurality of water-soluble scattering particles distributed therein.

2. The optical film device as claimed in claim 1, wherein said anti-glare film further includes a plurality of indentations distributed on a surface thereof.

3. The optical film device as claimed in claim 1, wherein said water-soluble scattering particles are colloidal particles.

4. The optical film device as claimed in claim 3, wherein said colloidal particles are made of a material selected from the group consisting of gelatin, hydrogel, and polyvinyl alcohol.

5. The optical film device as claimed in claim 1, wherein said transparent anti-glare film is made of a material selected from the group consisting of an ultraviolet curable resin, a thermoplastic resin, and a thermosetting resin.

6. The optical film device as claimed in claim 1, further comprising a light-transmissive substrate supporting said laminate.

7. The optical film device as claimed in claim 6, wherein said functional layers further include at least one film selected from the group consisting of a hard coat, an anti-static hard coat, a low reflection film, and an anti-reflection film.

8. The optical film device as claimed in claim 6, wherein said functional layers further include a film selected from the group consisting of a hard coat and an anti-static hard coat and disposed, between said transparent anti-glare film and said light-transmissive substrate.

9. The optical film device as claimed in claim 8, wherein said functional layers further include a film selected from the group consisting of a low reflection film and an anti-reflection film and covered on said anti-glare film.

10. The optical film device as claimed in claim 6, wherein said functional layers further include a hard coat disposed between said anti-glare film and said light-transmissive substrate, an anti-static hard coat covered on said anti-glare film, and a low reflection film covered on said anti-static hard coat.
